(19) United States
(12) Patent Application Publication
(10) Pub. No.: US 2008/0092077 A1
(43) Pub. Date: Apr. 17, 2008

(54) INTERACTIVE STREAMING NEWS HEADLINE DISPLAY

(75) Inventors: Timothy S. Mather, Englewood, CO (US); Jonathan D. Jaynes, Denver, CO (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: CQGT, LLC, Denver, CO (US)

(21) Appl. No.: 11/855,691

(22) Filed: Sep. 14, 2007

Related U.S. Application Data
(60) Provisional application No. 60/825,636, filed on Sep. 14, 2006.

(51) Int. Cl. G06F 3/048

(52) U.S. Cl. 715/781

(57) ABSTRACT

Systems and methods for displaying news headlines are provided. More specifically, embodiments of the present invention relate to interactive streaming news headline displays. According to various embodiments of the present invention, news headlines and/or stories can be presented in ways that improve “glanceability” over conventional methods. Some embodiments provide for receiving electronic news headlines from one or more electronic news providers. The electronic news headlines may includes metadata describing one or more attributes of a story associated with the electronic news headline. A graphical user interface is presented to a user through a display device. In one or more embodiments, the graphical user interface includes a main window pane and at lease one auxiliary window pane.

### CROSS-REFERENCE TO RELATED APPLICATIONS

This application claims the benefit of Provisional Application No. 60/825,636, filed on Sep. 14, 2006, which is hereby incorporated by reference in its entirety.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright © 2006-2007 CQGT, LLC.

### TECHNICAL FIELD

Various embodiments of the present invention generally relate to systems and methods for displaying news headlines. More specifically, the embodiments of the present invention relate to interactive streaming news headline displays.

### BACKGROUND

In the field of multimedia news, the presentation of news and news headlines are typically done using a variety of formats from television, newspaper, computer networks, and through other electronic systems. Traditional electronic news interfaces generally present headlines in a single window pane on the display and in a uniform format. For example, the electronic news interface may present the headlines on a display as they are received with a single preset font size, font style, and color. Thus, the headlines presented on the display will have a uniform appearance, which is generally not helpful to a user who is reading through the headlines trying to locate certain types of information. In addition, users often desire to monitor multiple news subjects simultaneously. The traditional news interfaces require that the user read each headline to determine if the news story relates to one of the subjects the user is interested in monitoring.

As such, there are a number of challenges and inefficiencies created in the display of news headlines through traditional news applications. The user is not able to quickly and easily review, select, and read news headlines and news stories. It is with respect to these and other problems that embodiments of the present invention have been developed.

### SUMMARY

Systems and methods are described for displaying news headlines. More specifically, the embodiments of the present invention described herein relate to interactive streaming news headline displays. According to various embodiments of the present invention, news headlines and/or stories can be presented in ways that improve “glanceability” over conventional methods. The news headlines may be presented in a hierarchical fashion. Various embodiments provide a news window that is divided into multiple panes. For example, the news window may include a hierarchical news headlines pane, a collapsible story reading pane, one or more auxiliary headline panes, and a news volume timeline pane.

One or more embodiments of the present invention provide for receiving electronic news headlines from one or more electronic news providers. The electronic news headlines may includes metadata describing one or more attributes of a story associated with the electronic news headline. A graphical user interface is presented to a user through a display device. The graphical user interface can include a main window pane and at lease one auxiliary window pane.

In one or more embodiments, the electronic news headlines are dynamically presented in the main window pane in chronological order based on the time the story was reported. According to various embodiments, the order of the headlines listed are based on a time stamp included in the metadata as the electronic news headlines are received from the one or more electronic new providers. In accordance with various embodiments, dynamically presenting the electronic news headlines includes deemphasizing the electronic news headlines currently in the main window pane (or headlines with an older time stamp) as new electronic news headlines are presented in the main window pane. In other (or overlapping) embodiments, other glanceability characteristics may be added to the presentation of the news headlines and stories.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

FIG. 1 illustrates an example of an operating environment in which embodiments of the present invention may operate (and/or be an integral part of).

FIG. 2 is a block diagram of various components in an example news client application that is capable of presenting news headlines and content in accordance with various embodiments of the present invention.

FIGS. 3-4 illustrate examples of graphical user interfaces that present news headlines in one or more window panes in accordance with various embodiments of the present invention.

FIG. 5 illustrates an example of a computing device upon which embodiments of the present invention can operate.

### DETAILED DESCRIPTION

Embodiments of methods and systems are described that provide for presenting news headlines. News headlines can be presented in ways that improve “glanceability” over conventional methods. The news headlines may be presented in a hierarchical fashion. Various embodiments provide a news window that is divided into multiple panes. For example, the news window may include a hierarchical news headline pane, a collapsible story reading pane, one or more auxiliary headline panes, and a news volume timeline pane.

In the hierarchical news headline pane, news headlines are presented hierarchically. The font size of news headlines may decrease with headline age or the font size may vary based on news headline importance. Headline font intensity may fade as a headline ages. The news headlines may be presented in colors that correspond to relevant attributes. For example, news headlines that are considered to be “hot stories” may be presented in red. Colors may be user-configurable, so that the user can designate a color for headlines that pertain to a certain topic. For example, all headlines related to stories about cattle may be presented in a selected color, such as green.

In one or more embodiments, a user may select a filter based on characteristics of the news headlines, content, and/or metadata which may limit the set of displayable headlines to that subset of all headlines that match the selected filter criterion. Filters may be predefined or may be defined according to parameters specified by the user.

The news volume timeline pane includes a timeline with histogram bars that represent a count of news headlines that were received at a corresponding time. In one or more embodiments, the timeline histogram bar may represent the count of all news headlines at the corresponding time while in an alternative embodiment they may represent the count of only the headlines matching the currently selected filter criterion. A histogram bar may be colored to indicate the existence of a headline with a special property such as “hot story” at the corresponding time.

The timeline may be functionally linked to the hierarchical news headline pane. When the user selects a time in the timeline, the hierarchical pane “jumps” to the news headlines at the selected time. In one or more embodiments, if the headline for the story currently being viewed in the story reading pane is no longer visible in the headline window pane, a marker may be placed on the timeline at the time corresponding to the viewed story.

In one or more embodiments, the timeline may act as a scroll bar, allowing the user to scroll through the headlines, whereby, for example, as the user moves a timeline slider through time in the timeline, the corresponding news headlines scroll vertically in the hierarchical new headline pane. In one or more embodiments, the timeline pane may be collapsible.

Auxiliary panes can present headlines more particularly based on filters functionally linked thereto. Thus, when a filter is linked to an auxiliary pane, only headlines that pass the associated filter will be presented in the auxiliary pane. For example, one auxiliary pane may show only headlines that are designated as “Hot” stories. As another example, a user may define a filter that passes only news headlines for stories that mention the “Federal Reserve.” Auxiliary window panes may be collapsible.

In various embodiments, the news story associated with a headline is presented in a reading pane when the user selects the news headline in the hierarchical news pane. The user can select the news headline by using a computer mouse to “click” on the news headline. The reading pane may be collapsible.

Terminology

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrase “glanceability characteristics” generally refers to any manner of presenting or characteristic of information being presented that assists a user to make decisions or otherwise recognize aspects of the information based on a quick look at the information. Examples of glanceability characteristics include, but are not limited to, font size, font color, font style, font intensity, organization of the information being presented, presentation of information in multiple windows, marking stories based on filtering criteria, and the like. In one or more embodiments, for example, glanceability characteristics include decreasing a font size of news headlines based on headline age, setting headline font intensity based on headline age, and color coding news headlines based on news headline attributes. Another example of a glanceability characteristic includes placing news headlines in different window panes based on filtering criteria.

Phrases utilizing the term “embodiment” do not necessarily refer to the same embodiment.

If the specification states a component or feature “may”, “can”, “could”, or “might” be included or have a characteristic, that particular component or feature is not required to be included or have the characteristic.

The term “responsive” includes completely or partially responsive.

The phrases “memory store” or “data store” generally refer to any device, mechanism, or populated data structure used for storing information. For purposes of this patent application, “memory store” or “data store” are intended to encompass, but are not limited to, one or more databases, one or more tables, one or more files, volatile memory, nonvolatile memory and dynamic memory. By way of further illustration, for example, random access memory, memory storage devices, and other recording media are covered by the phrase “memory store” or “data store.” Common examples of a memory store include, but are not limited to, magnetic media such as floppy disks, magnetic tapes, hard drives and/or the like. Other examples of “memory stores” include SIMMs, SDRAM, DIMMs, RDRAM, DDR RAM, SODIMMS, optical memory devices such as compact disks, DVDs, and/or the like. In addition, a “memory store” may include one or more disk drives, flash drives, databases, local cache memories, processor cache memories, relational databases, flat databases, and/or the like. This list is no way meant to be an exhaustive list of devices and/or data structures falling with in the definition of “memory store,” but is instead meant to highlight some examples. Those skilled in the art will appreciate many additional devices and techniques for storing information which are intended to be included within the phrase “memory store.”

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

Example Operating Environment

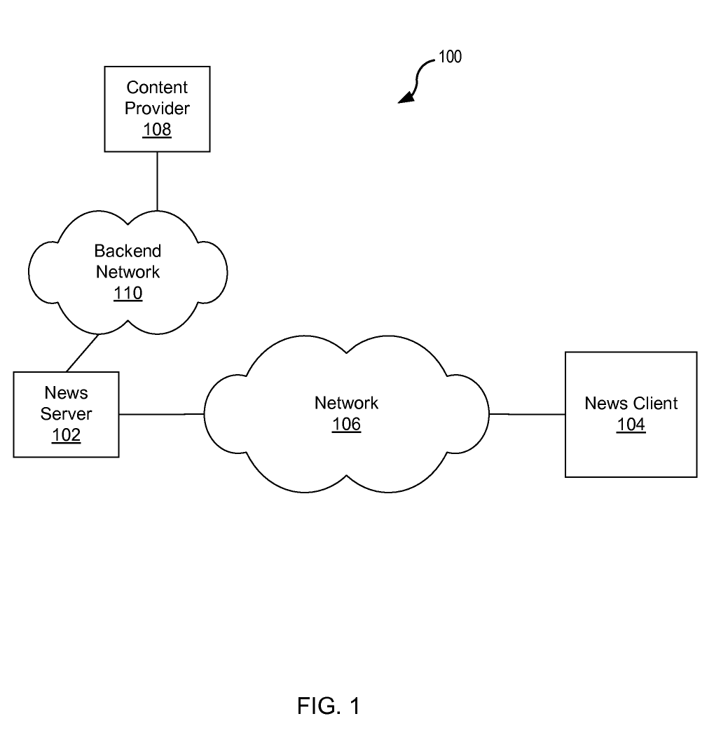

FIG. 1 illustrates an example operating environment 100 in which embodiments of the present invention may be employed. One or more news servers 102 serve news headlines and content to one or more clients 104 via a network 106. The network 106 may be a private network or a public network, such as the Internet. The network 106 may be wired, wireless, or any combination thereof, and may comprise multiple networks, such as, but not limited to, an Internet Service Provider (ISP) network, an autonomous system, a carrier provider network, virtual private network (VPN), or a backbone network.

With further regard to the news server 102, news content and headlines are generally obtained from one or more content servers (not shown), which may be affiliated with content providers 108, such as news corporations (e.g., Dow Jones™, Market News Service™). In various embodiments, the news server 102 includes a database server application (not shown) that provides access to a database (not shown) that includes news content and headlines provided by news content providers. The news server 102 and the content providers 108 may communicate via a backend network 110. The news server 102 may collect news content, including headlines, and send the content and headlines to the client 104. The news server 102 can provide streaming headlines using a real-time feed.

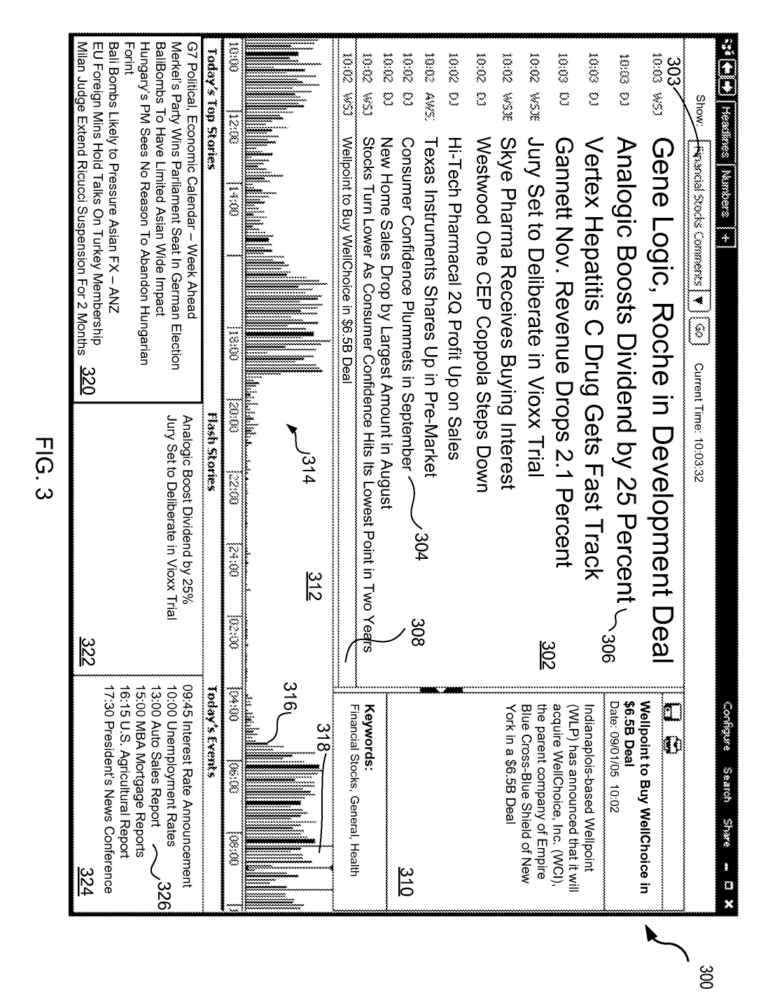

The news client 104 runs a client application that is operable to receive news content and headlines from the news server 102 and present headlines and content to a user of the news client 104. In addition to news headline and content presentation, the client application may or may not include other functionality such as financial data presentation or electronic exchange interaction, whereby the user of the news client 104 can place bids and asks on financial instruments. Presentation of the news headlines and content by the news client application may include presenting a graphical user interface. FIG. 3, discussed further below, illustrates embodiments of a graphical user interface that may be presented by the news client application.

Although the environment of FIG. 1 depicts only one news server 102, one news client 104, and one content provider 108, in actual operation, it will be understood that there can be multiple news servers 102, multiple news clients 104, and/or multiple content providers 108.

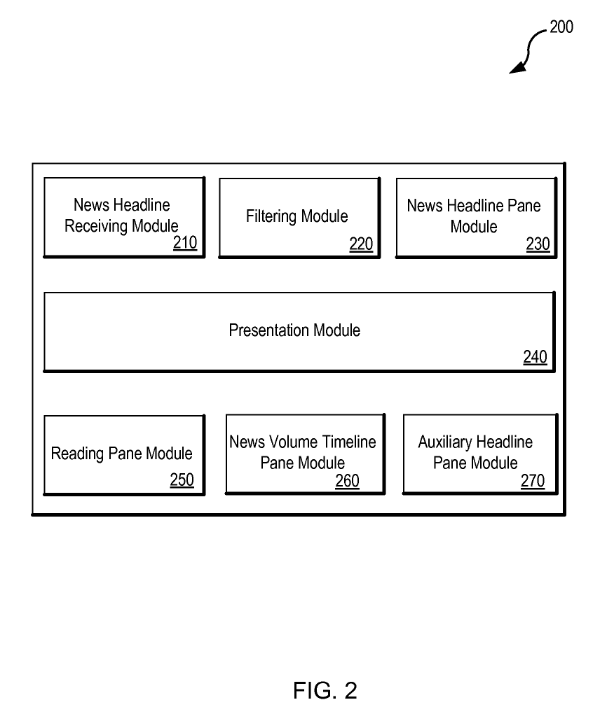

FIG. 2 is a block diagram of various components in an example of a news client application 200 that is capable of presenting news headlines and content in accordance with various embodiments of the present invention. According to one or more embodiments, news client application 200 is a client application running on news client 104. As shown in FIG. 2, news client application 200 includes a news headline receiving module 210, a filtering module 220, news headline pane module 230, presentation module 240, reading pane module 250, news volume timeline pane module 260, and auxiliary headline pane module 270. In general, various embodiments envisioned by FIG. 2 may include some, all, or none of these modules along with other modules or application components. Still yet, various embodiments may incorporate two or more of these modules into a single module and/or associate a portion of the functionality of one or more of these modules with a different module. For example, in various embodiments, the various “pane” modules (e.g., 230, 250, 260, 270) can collectively be considered part of a graphical user interface module.

News headline receiving module 210, according to one or more embodiments of the present invention, provides an interface between the news client 104 and one or more news servers 102. For example, news headline receiving module 210 is able to receive and process one or more feeds of streaming news headlines and associated news content from one or more news sources such as news server 102. In addition, news headline receiving module 210 translates any requests from the news client application into a format required by a destination component. Similarly, module 210 is able to translate and/or direct incoming requests and/or data to the appropriate module within the news client application.

Once news headline data and/or news story data is received through news headline receiving module 210, filtering module 220 filters the received news headlines and associated stories. In one or more embodiments, metadata is received along with the news headlines and/or stories. Examples of the type of information included in the metadata may include, but are not limited to, a time stamp, name of the news source, keywords within the story, name of the author of the story, country where the story originated, lists of related stories, importance rating, and other information. In various embodiments, the metadata may be added or modified manually or automatically through the news client application 200.

In one or more embodiments of the present invention, a user using news client application 200 may select one or more filtering preferences about the news headlines and/or stories being presented. For example, a trader may prefer to see only news headlines and/or stories from a particular news source. In other cases, a user may prefer to see only news headlines and/or stories related to a particular subject (e.g., financial news). In various embodiments, a user interface may be provided allowing the user to customize which headlines and/or stories will be presented. The user interface may include dialog boxes for selecting certain preferences, command lines for entering certain key words, and the like. In one or more embodiments, preset filters may be provided for the user to select. Once the filtering rules are selected or set, filtering module 220 filters the news stories and/or news headlines received from the news server(s) 102 based on the filtering preferences or rules. Module 220 then communicates the results to other modules, such as news headline pane module 230, presentation module 240, reading pane module 250, and/or auxiliary headline pane module 270.

In one or more embodiments of the present invention, a headline database (not shown in FIG. 2) is communicably coupled to the news headline receiving module 210. The headline database can be any type of memory store which is capable of storing the streaming news headlines and/or associated news content received by news headline receiving module 210. The news headlines and/or news content received from the news server(s) 102 may be stored in the headline database and accessed for later use. When a request is made to access a news headline and/or news story, receiving module 210 may also be used to gather the requested item(s). In various embodiments, presentation module 240 is communicably coupled to the headline database and presents on a display device the streaming news headlines stored in the headline database. In general, the presentation of the streaming news headlines may be, for example, in chronological order from a most recent news headline to an oldest news headline and with glanceability characteristics. Examples of other presentation schemes and glanceability characteristics are discussed in more detail below.

In one or more embodiments, a news headline pane module 230 creates a first window pane on a display device and presents the streaming news headlines which have been received from filtering module 220. In other embodiments, no filtering is performed on news headlines presented in the first window pane. One example of a news headline pane is illustrated in window pane 302 in FIG. 3.

Reading pane module 250 creates a second window pane on the display device in response to a user selection of one of the streaming news headlines presented on the display device and displays the news content associated with the user selected streaming news headline. One example of a reading pane is shown by window pane 310 in FIG. 3. According to various embodiments, reading pane module 250 allows the user to quickly print, save, and/or e-mail the stories presented in the second window pane. Also, in various embodiments, related stories may be presented in the second window pane in a concatenated manner.

Auxiliary headline pane module 270 creates a third window pane on the display device and presents a subset of the streaming news headlines in the third window pane based on a set of filtering criteria. This set of filtering criteria may be a second set of filtering criteria and may be applied to all incoming stories or to the first filtered results. In one or more embodiments, multiple window panes may be created by auxiliary headline pane module 270 where each such pane has a different filter. FIG. 3 show three examples of window panes (window panes 320, 322, and 324) that may be created by auxiliary pane module 270.

In various embodiments, news volume timeline pane module 260 creates a window pane on the display device and present a news volume timeline in that window pane. The news volume timeline may include statistical information about the news stories over time. The type of volume timeline displayed in this window may depend on user preference, the type of display, and/or desired user interactions with the volume timeline. For example, in one or more embodiments, a histogram with bars representing a volume of news headlines at a corresponding time is presented in this aforementioned window pane. One example of a volume timeline is illustrated in window pane 312 in FIG. 3.

One or more embodiments provide for anchoring lines on the news volume timeline allowing the user to grab the line and place it to a new position on the timeline. In various embodiments, this action will result in an update of the news headlines and stories presented in the first window pane to the time period encompassed by the anchoring line.

In the example shown by FIG. 3, a news presentation Graphical User Interface (GUI) 300 presents news headlines in one or more formats and/or according to one or more filters. The news headlines and/or content can be displayed on a display monitor of a client computer. Sets of news headlines can be shown in multiple window panes. Although six window panes are illustrated in the GUI 300 of FIG. 3, it should be understood that not all the window panes are required and that more panes may be included. In fact, as discussed further below, some, or all, of the window panes can be collapsed, so that they can be reduced in size or not shown at all. In addition, the panes can be rearranged in any manner that is useful to the user.

News headlines that are received are shown in a first window pane 302. The news headlines presented in the first window pane 302 may or may not be filtered. Using a filter drop-down menu 303, the user can select a filter from a list of one or more filters, which is to be applied to streaming news headlines in the window pane 302. The list of filters may be pre-defined or user defined. The news headlines can be presented in the window pane 302 in a substantially real time manner as they are received at the client computer. The news headlines can be shown in a hierarchical manner using various hierarchy schemes.

For example, the hierarchy may be time based. In this case, the text of news headlines can be altered in one or more ways as the news headlines age. In the example shown in FIG. 3, the news headlines become smaller as they age. To illustrate, the headline “Consumer Confidence Plummets in September” 304 at time 10:02 is older than the headline “Analog Boosts Dividend by 25 Percent” 306 at time 10:03; as such, the text of the news headline “Consumer Confidence Plummets in September” 304 appears smaller than the text of the more recent news headline “Analog Boosts Dividend by 25 Percent” 306. In accordance with some embodiments of the present invention, the text of headline “Consumer Confidence Plummets in September” 304 may be faded or other properties such as the text color may be modified as compared to the text of headline “Analog Boosts Dividend by 25 Percent” 306.

As another example, the hierarchy scheme may be based on relative importance. Some content providers include an importance indicator associated with more important news headlines. In some embodiments, this indicator is called a “Hot Story”. As such, the more important news headlines can be presented more prominently than the less important news headlines. One way of presenting more important news headlines more prominently can be to present the more important news headlines in a brighter color. To illustrate, the news story “Analog Boosts Dividend by 25 Percent” 306, which is considered to be more important, can be presented in red, while other, less important news headlines can be presented in gray. Other ways of displaying news headlines more prominently include, but are not limited to, bolding, italicizing, or presenting in a different distinctive font type.

News headlines in the window pane 302 can also be presented according to a customized filter. A news headline filter includes specified parameters that the filter looks for in incoming news headlines. Any news headlines having those parameters are selected by the filter. The filter also includes an action, which designates an action to take with respect to news headlines selected by the filter. For example, an action could be to color the text of the news headline a specified color. The action may also specify one or more window panes to show the news headline in. The user can customize the filter by specifying the filter parameters and actions.

In the example shown in FIG. 3, when the user selects one of the news headlines, the content associated with the selected news headline is presented in another window pane. Typically, content is retrieved from the news server in response to the user selecting the associated headline. However, the selected content may be retrieved from a local memory in some cases. For example, if content has been retrieved previously, the content may be cached locally in a local memory store and retrieved from the memory store when the headline associated with the content is selected. In one embodiment, the content may be stored in a headline database and retrieved from the cache when it is selected.

In some embodiments, the user can select a news headline by clicking once on the news headline using a computer mouse or other similar device. To illustrate, in FIG. 3, the headline “WellPoint to Buy WellChoice in $6.5 B Deal” 308 is selected, as shown by a box around the text of the headline. The news content associated with the news headline 308 is presented in another window pane 310. The news content window pane 310 can be collapsible by the user, and can automatically reappear when a news headline is selected again.

A timeline window pane 312 presents a news volume timeline 314. In the news volume timeline 314, time is presented from left (earliest) to right (latest). News volume bars 316 are presented at various times of the timeline 314. The news volume bars 316 are sized according to the relative volume of news headlines received at the associated time: a taller bar indicates more news headlines were received at the associated time than at another time that has a smaller associated bar.

Each bar 316 can be presented in a manner that corresponds to the way the news headlines are presented based on hierarchy schemes or filters in the associated time period. For example, if a news headline is received that has a “Hot Story” indicator, the news volume bar associated with the time period that the news headline was received could be highlighted by bolding the associated news volume bar or by displaying it in an alternate color such as red. As such, the news volume bars 316 are presented in a manner that enables the user to quickly identify whether news stories of interest were received in a certain time period.

Typically, the timeline 314 will span a broader range of time and news headlines than the news headline pane 302. To illustrate, the news headline window 302 includes news headlines received at times 10:02 through 10:03, while the timeline 314 spans a 24 hour period (e.g., from 10:00 am to 10:00 am). The user can use a slider 318 to scroll to different points in the timeline 314. The user can also click at selected locations in the timeline 314. When the user navigates to a selected time period in the timeline 314, the news headlines associated with the selected time period are shown in the headlines pane 302 and the slider 318 is positioned on the timeline 314 to reflect the selected time period. Thus, the timeline 314 is linked to the news headline pane 302.

When a new more recent bar is presented, it is present to the right of all bars on the timeline 314, bars to the left are shifted left, and the left most bar is deleted from the timeline 314.

One or more auxiliary window panes can be presented in the GUI 300. News headlines can be presented in these window panes based on filters. The filters may be user-customized or they may be predefined by the client news application.

In one or more embodiments, the news headlines presented in each of the auxiliary news headlines window panes can be associated with, or include, one or more common characteristics. To illustrate, in a “Today's Top Stories” auxiliary window pane 320, the day's top news headlines are presented. In a “Flash Stories” auxiliary pane 322, stories that are selected by an associated filter are presented. The filter may be user-defined, such that stories, headlines, or associated metadata that include a certain word or phrase will have their associated headline presented in the window pane. For example, the user may define a filter that selects headlines associated with cattle and hogs.

In a daily events window auxiliary pane 324, titles or headlines of daily events are presented. These events may be scheduled, such that they occur periodically and predetermined times. As an example, a headline for “Auto Sales Report” 326 can be presented in the daily events pane 324. In various embodiments, the news headlines of the auxiliary panes 320, 322, and 324 are persistent. As such, for example, a certain number of the most recent headlines of the associated type will persist in the panes. The headlines or titles presented in the auxiliary panes 320, 322, and 324 are selectable by the user, as are the headlines of pane 302.

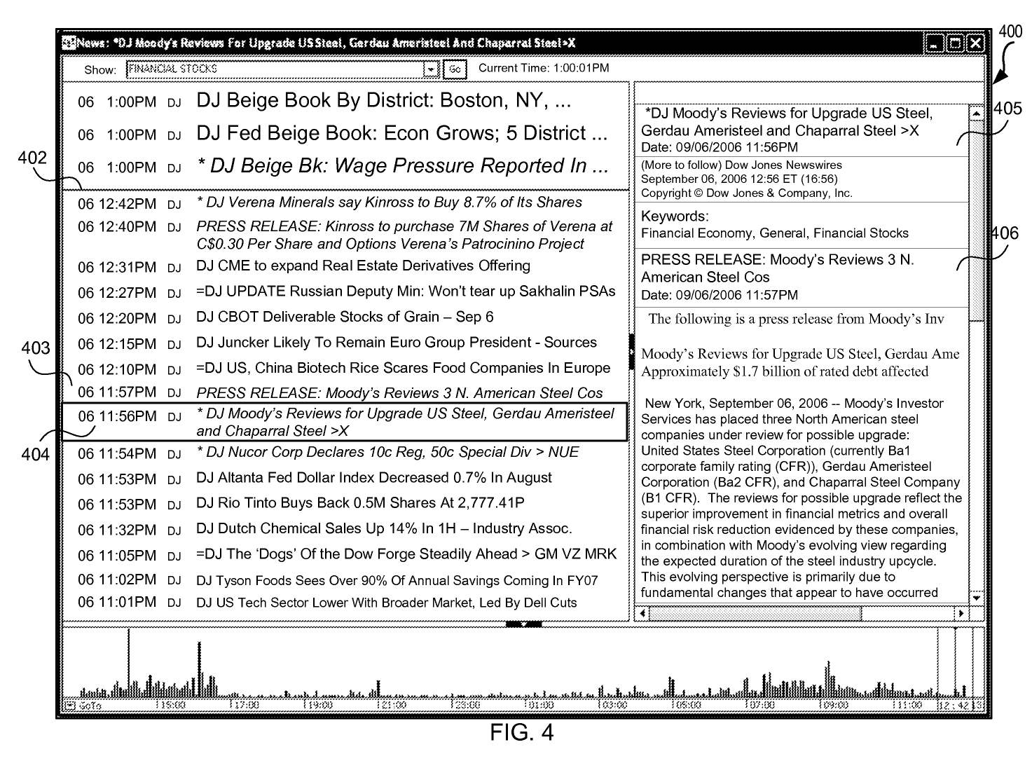

FIG. 4 illustrates another example of a graphical user interface (GUI) for presenting news headlines and news in accordance with various embodiments. In this example, the GUI 400 is similar to GUI 300, but, e.g., the auxiliary panes are not displayed in the GUI 400.

In addition, GUI 400 includes an automatic divider 402 that divides a number of the most recently received news headlines (above the divider 402) from older headlines (below the divider 402). The divider 402 automatically appears when the user scrolls through older news headlines. When the headlines in the window pane 302 are consecutive, the divider 402 is not presented. However, when the user begins scrolling through past headlines, the divider 402 automatically appears. The divider 402 indicates that the bottom-most headline of the most recent headlines above the divider 402 is not consecutive with the top-most headline in the older headlines shown below the divider 402. When the user scrolls forward through the headlines and the headlines again become consecutive, the divider 402 automatically disappears.

In a news reader graphical user interface, it may be desirable to distinguish between unread and read stories. In the example presented in GUI 400, the headlines for stories that have been read are distinguished from unread stories by displaying the headlines of read stories using an italicized font. Other ways of distinguishing read news headlines may include, but are not limited to, presenting the read headline in a different distinctive font type.

Some news services may include metadata with a headline that links one story with another. In the example presented in GUI 400, the headline 403 is linked with the prior headline 404. The reading window pane includes the text 405 that corresponds to the headline 404 as well as the text 406 that corresponds to the headline 403. While in this example, only two stories are linked, this is not a limitation of the user interface.

Exemplary Computing Device

Embodiments of the present invention include various steps, which are described herein and the associated appendix. The steps may be performed by hardware components or may be embodied in machine-executable instructions, which may be used to cause a general-purpose or special-purpose processor programmed with the instructions to perform the steps. Alternatively, the steps may be performed by a combination of hardware, software, firmware or human representatives of the parties or entities involved in the transaction.

Embodiments of the present invention may be provided at least in part as a computer program product, which may include a machine-readable medium having stored thereon instructions, which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

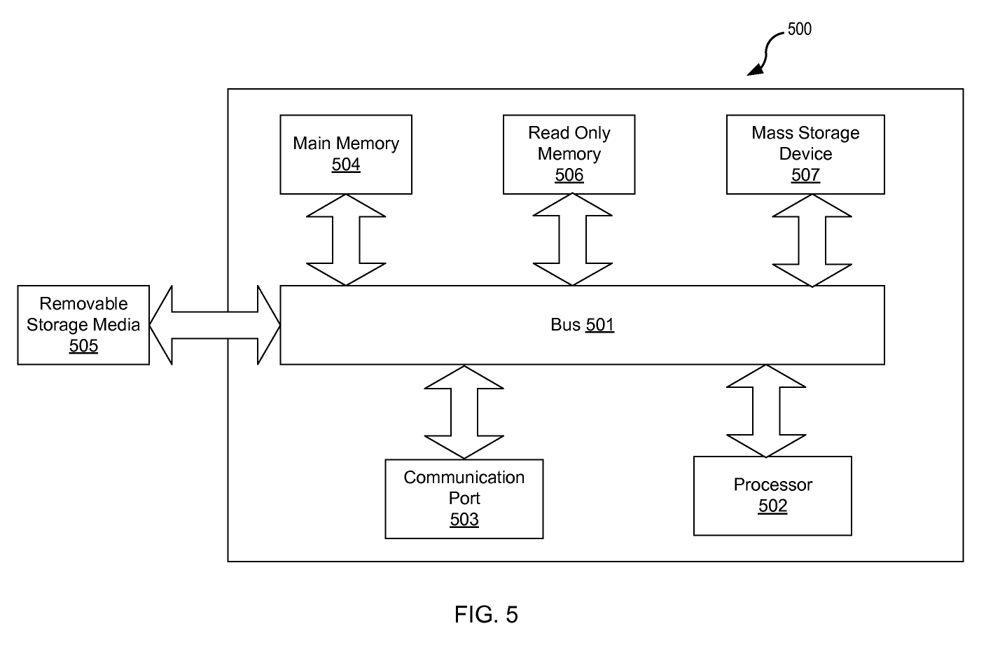

FIG. 5 is a schematic diagram of a computing device 500 upon which a news server or news client application may execute. According to the present example, the computing device 500 includes a bus 501, at least one processor 502, at least one communication port 503, a main memory 504, a removable storage media 505 a read only memory 506, and a mass storage 507. Processor(s) 502 can be any know processor, such as, but not limited to, an Intel® Itanium® or Itanium 2® processor(s), or AMD® Opteron® or Athlon MP® processor(s), or Motorola® lines of processors. Communication port(s) 503 can be any of an RS-232 port for use with a modem based dialup connection, a 10/100 Ethernet port, or a Gigabit port using copper or fiber. Communication port(s) 503 may be chosen depending on a network such a Local Area Network (LAN), Wide Area Network (WAN), or any network to which the computing device 500 connects. The computing device 500 may be in communication with peripheral devices (not shown) such as, but not limited to, printers, speakers, cameras, microphones, or scanners.

Main memory 504 can be Random Access Memory (RAM), or any other dynamic storage device(s) commonly known in the art. Read only memory 506 can be any static storage device(s) such as Programmable Read Only Memory (PROM) chips for storing static information such as instructions for processor 502. Mass storage 507 can be used to store information and instructions. For example, hard disks such as the Adaptec® family of SCSI drives, an optical disc, an array of disks such as RAID, such as the Adaptec family of RAID drives, or any other mass storage devices may be used.

Bus 501 communicatively couples processor(s) 502 with the other memory, storage and communication blocks. Bus 501 can be a PCI/PCI-X or SCSI based system bus depending on the storage devices used. Removable storage media 505 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

Various modifications and additions can be made to the embodiments discussed herein without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations together with all equivalents thereof.

While, for convenience, embodiments of the present invention are described herein with reference to specific news presentation schemes, the techniques described are equally applicable to various other types and structures of charts and news or trading paradigms.

We claim:

1. A computer-implemented method for presenting news headlines in a graphical user interface window having at least a first and second window pane, comprising:
1) receiving news headlines from a news server;
2) hierarchically presenting the news headlines in the first window pane;
3) presenting a news volume timeline in the second window pane, wherein the news volume timeline contains at least one discrete user-selectable time; and
4) functionally linking the news volume timeline to the first window pane, such that when a user selects a time in the timeline, the first window pane presents news headlines corresponding to the selected time.

2. The computer-implemented method of claim 1, wherein the hierarchical presentation of the news headlines includes a chronological presentation based on a time stamp associated with the news headlines.

3. The computer-implemented method of claim 1, further comprising a third window pane that, in response to a selected news headline from the news headlines presented in the first window pane, displays a news story associated with the selected news headline.

4. The computer-implemented method of claim 3, further comprising automatically placing a marker on the news volume timeline at a time corresponding to the selected news headline when the selected news headline is no longer visible in the first window pane.

5. A computer-based system comprising:
a display device operable to display a graphical user interface;
a display input/output device communicably coupled to the display device;
a news headline receiving module configured to receive one or more feeds of news headlines and associated news content from one or more news sources;
a headline database communicably coupled to the receiving module, wherein the headline database is configured to store the news headlines and associated news content received by the news headline receiving module;
a presentation module communicably coupled to the headline database and the display input/output device, wherein the presentation module presents the news headlines stored in the headline database on the display device in chronological order from a most recent news headline to an oldest news headline and with one or more glanceability characteristics.

6. The computer-based system of claim 5, wherein the one or more glanceability characteristics of the news headlines are chosen from a group consisting of decreasing a font size of news headlines, setting headline font intensity, and color coding news headlines based on news headline attributes.

7. The computer-based system of claim 5, further comprising a graphical user interface module communicably coupled to the presentation module, wherein the graphical user interface module is configured to create one or more selected window panes and display information therein in response to information received from the presentation module, wherein the graphical user interface module includes:
a news headline pane module to create a first window pane on the display device and present the news headlines therein;
a reading pane module to create a second window pane on the display device in response to a user selection of one of the news headlines presented on the display device and display the news content therein associated with the user selected news headline;
a news volume timeline pane module to create a third window pane on the display device and present a news volume timeline in the third window pane, wherein at least one portion of the news volume timeline represents a volume of news headlines at a corresponding time; and
an auxiliary headline pane module to create a one or more additional window panes on the display device and present a subset of the news headlines in each of the one or more additional window panes based on a set of filtering criteria associated with each of the one or more additional window panes.

8. A computer-implemented method comprising:
receiving electronic news headlines from one or more electronic news providers, wherein the electronic news headlines includes metadata describing one or more attributes of a story associated with the electronic news headline;
displaying a graphical user interface window including a main window pane and an auxiliary window pane;
dynamically presenting the electronic news headlines in the main window pane in chronological order based on a time stamp included in the metadata as the electronic news headlines are received from the one or more electronic new providers; and
deemphasizing the electronic news headlines currently in the main window pane as new electronic news headlines are presented in the main window pane.

9. The computer-implemented method of claim 8, wherein deemphasizing the electronic news headlines currently in the main window pane as new electronic news headlines are presented in the main window pane includes altering the font of the electronic news headlines to indicate the age of the electronic news headlines.

10. The computer-implemented method of claim 8, further comprising:
receiving filtering criteria;
filtering the electronic news headlines based on the received filtering criteria; and
presenting the filtered electronic news headlines in the auxiliary window pane.

11. The computer-implemented method of claim 8, wherein dynamically presenting the electronic news headlines further includes adding one or more glanceability characteristics to the electronic news headlines selected from a group consisting of decreasing font size with headline age, color coding headlines based on the metadata of the electronic news headline, and filtering the electronic news headlines presented based on content.

12. The computer-implemented method of claim 8, further comprising displaying a news volume timeline pane in the graphical user interface window, wherein the news volume timeline pane includes a time chart representing a count of news headlines that were received at a corresponding time.

13. The computer-implemented method of claim 12, wherein the time chart is a histogram bar chart, and wherein a bar of the histogram time chart is colored to indicate a headline with a desired attribute at the corresponding time.

14. The computer-implemented method of claim 12, further comprising placing a marker on the time chart when a selected story being displayed in a reading pane has been removed from view in the main window pane.

15. The computer-implemented method of claim 12, further comprising:
monitoring for a selection of a time in the news volume timeline pane; and
presenting news headlines from the time selected in the main window pane.

16. The computer-implemented method of claim 8, further comprising:
displaying a reading pane that displays a news story associated with a selected electronic news headline;
determining related stories based on the metadata associated with the selected electronic news headline; and
displaying the determined related stories in the reading pane in a concatenated manner.

17. A computer-implemented method comprising:
displaying a first user interface screen on a terminal, the first user interface screen a main window pane capable of presenting a plurality of news headlines, wherein the news headlines are presented in hierarchical order and a font is chosen for each of the news headlines to indicate the hierarchical order of the news headlines;
displaying a reading window pane within the first user interface screen on the terminal in response to a selection of a news headline presented in the main window pane, wherein all related stories as indicated by metadata associated with the selected news headline are presented in the reading window pane; and
dynamically updating the main window in the first user interface screen with news headlines as they are received from one or more electronic news sources.

18. The computer implemented method of claim 17, further comprising filtering the plurality of news headlines based on a set of filtering criteria and changing a glanceability characteristic of any news headlines which meet the filtering criteria.

19. The computer implemented method of claim 18, wherein the glanceabiliy characteristic is selected from the group consisting of decreasing a font size of news headlines, setting headline font intensity, and color coding news headlines based on news headline attributes.

20. The computer implemented method of claim 17, further comprising:
creating an auxiliary window pane within the first user interface screen on the terminal;
filtering the plurality of news headlines based on a set of auxiliary filtering criteria; and
presenting any of the plurality of news headlines that meet the set of auxiliary filtering criteria.

21. The computer implemented method of claim 17, wherein the hierarchical order is a chronological order based on news headline age.

22. The computer implemented method of claim 17, wherein the hierarchical order is based on importance indicators included in metadata associated with the news headline.

23. The computer implemented method of claim 17, wherein the hierarchical order is based on relative matching to a set of filtering criteria.

24. A computer-readable storage medium containing a set of instructions capable of causing one or more processors to:
receive electronic news headlines from one or more electronic news providers, wherein the electronic news headlines includes metadata describing one or more attributes of a story associated with the electronic news headline;
display a graphical user interface window including a main window pane and an auxiliary window pane; and
dynamically present the electronic news headlines in the main window pane in chronological order of the story based on a time stamp included in the metadata as the electronic news headlines are received from the one or more electronic new providers, wherein dynamically presenting includes deemphasizing the electronic news headlines currently in the main window pane as new electronic news headlines are presented in the main window pane.
